(19) United States
(12) Patent Application Publication
(10) Pub. No.: US 2008/0301942 A1
(43) Pub. Date: Dec. 11, 2008

(54) Method for manufacture of complex heat treated tubular structure

(75) Inventors: Wuhua Yang, Ann Arbor, MI (US); Charles J. Bruggemann, Rochester Hills, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 11/758,038

(22) Filed: Jun. 5, 2007

(51) Int. Cl. B23P 17/00

(52) U.S. Cl. 29/890.08

(57) ABSTRACT

A method for manufacturing a complex heat treated tubular structure includes making a tube assembly having tube portions along its length of differing characteristic. The tube assembly is formed by lengthwise tube bending and hydroforming to provide a desired shape. The tube is formed by lengthwise tube bending and hydroforming to provide a desired shape. The tube is fixedly supported in a locating fixture having a plurality of supports spaced along the tube to support the tube against distortion. A local region of the tube is heated in at least one local region to a temperature to heat treat the local region. A quenching medium is then flushed through the hollow interior of the tube, and the tube is removed from the locating fixture.

### FIELD OF THE INVENTION

The present invention relates to a method of manufacturing a heat treated and shaped tubular structure.

### BACKGROUND OF THE INVENTION

It is known in the manufacture of vehicles and other articles to utilize metallic hollow tubes that are assembled and formed to provide complex and precise tubular structures that are both dimensionally accurate and of high strength.

Furthermore, it is known that metals can be heat treated to alter the physical and metallurgical properties of the metal. Such heat treating processes involves the heating of the metal to a degree that affects the crystal phase of the metal microstructure, and then quickly cooling the metal in a quenching bath. Depending on the alloy and other considerations, such as concern for maximum hardness vs. cracking and distortion, cooling may be done with forced air or other gas, or a liquid such as oil, a polymer dissolved in water, water or brine. Upon being rapidly cooled, the microstructure of the metal is altered. Depending upon the temperature that is reached, and the nature of the quenching, the desired characteristic of toughness, ductility and strength can be obtained.

It would desirable to provide improvements in the manufacture of tubular structures in order to enable and perform the efficient joining together and forming and reliable heat treating of complex formed and shaped tubular structures made of formed tubes.

### SUMMARY OF THE INVENTION

A method for manufacturing a complex heat treated tubular structure includes making a tube assembly having tube portions along its length of differing characteristic. The tube assembly is formed by lengthwise tube bending and hydroforming to provide a desired shape. The tube is fixedly supported in a locating fixture having a plurality of supports spaced along the tube to support the tube against distortion. A local region of the tube is heated in at least one local region to a temperature to heat treat the local region. A quenching medium is then flushed through the hollow interior of the tube, and the tube is removed from the locating fixture.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is an elevation view of a tubular structure that has been assembled by end to end welding together of three tube portions; and

FIG. 2 is an elevation view of a tubular structure clamped in a locating fixture and connected to a source of quenching medium.

### DETAILED DESCRIPTION OF THE EXEMPLARY EMBODIMENTS

The following description of certain exemplary embodiments is exemplary in nature and is not intended to limit the invention, its application, or uses.

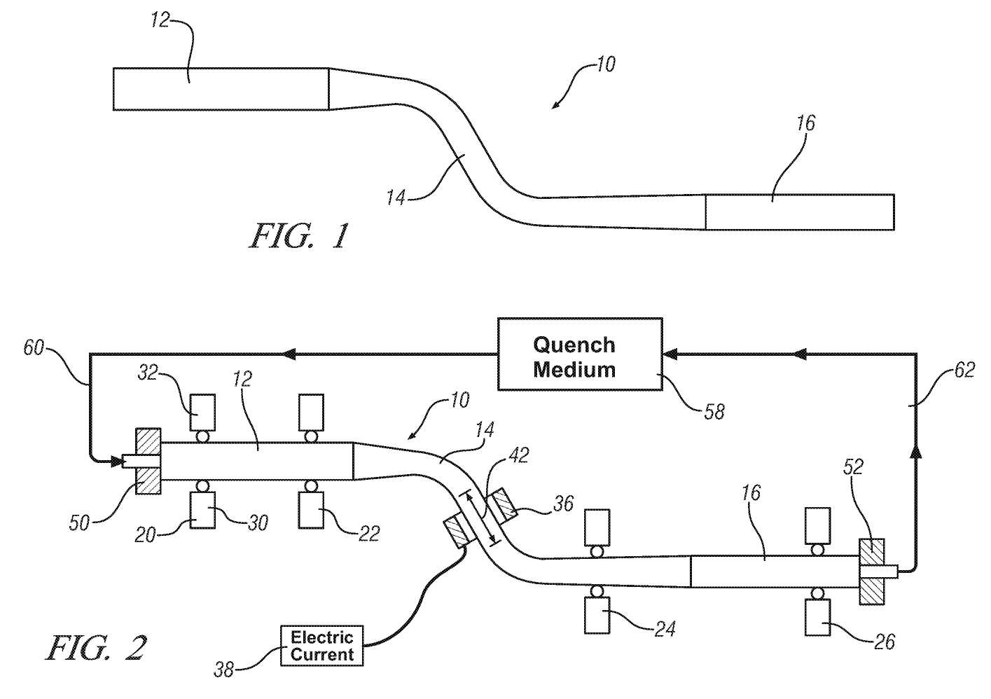

Referring to FIG. 1, a tube assembly, generally indicated at 10 is comprised of three separate tube portions 12, 14 and 16 that have been joined together end to end. The tube portions may have differing characteristic in order to provide variations in different regions of the tubular assembly. For example, the tubes can have different wall thickness, different alloying materials, different surface coatings, etc. The tube portions can be butted together or can be overlapped, and are preferably welded together to provide a high strength connection between the tubular portions. Alternatively, separate flat blanks of different material characteristics can be welded together end to end and then rolled to form a tube assembly having different characteristic portions along the length of the tube assembly.

As seen in FIG. 1, the center tube portion 14 has been bent along its axial length, either before or after being welded to the tube portions 12 and 16. Such bending operations are well known and typically performed in an automated tube bending apparatus.

In addition, the tube portions can be formed to vary the cross sectional shape thereof, preferably by hydroforming. Such hydroforming operations are well known and involve the capture of the tube within a cavity of a die and then the pressurization of a fluid within the tube to expand the tube outwardly into the shape of the die cavity. The hydroforming operation can be performed either before the tube portions are welded together end to end or after the tube portions are welded together end to end.

In FIG. 2, the tube assembly 10 of FIG. 1 is subjected to a heat treating process. The tube assembly 10 has been placed in a locating fixture that includes spaced apart fixtures 20, 22, 24, and 26. Fixture 20 is typical of the fixtures and includes a lower cradle 30 that supports the weight of the tube assembly 10 and an upper clamp 32 that clamps the tube in place on the lower cradle 30. The upper clamp 32 can be manually operated or is preferably operated by a hydraulic or pneumatic or motorized mechanism.

An induction coil 36 is situated around the tube portion 14 and connected to an electrical current source 38. When electrical current is conducted to the induction coil 36, a local region 42 of the tube assembly 10 is heated to a temperature in the range of 850 to 950 degrees C. for a typical steel, or a different temperature for other materials such as heat treatable aluminum or other alloys, in order to affect the crystal structure of the metal, while the tube assembly 10 is fixedly supported by the fixtures 20, 22, 24, and 26 to prevent distortion. Upon reaching the desired temperature, the electrical current is switched off and a quenching medium is flowed through the tube assembly 10. In particular, as shown in FIG. 2, an inlet seal 50 is installed in the left hand end of the tube assembly 10 and an outlet seal 52 is installed in the right hand end of the tube assembly 10. The inlet seal and the outlet seal 52 are connected to a quenching medium source 58 by hoses or piping or ducts 60 and 62. The quenching medium may be a liquid, in which case the quenching medium source 58 is a tank, a pump and associated valves. The quenching medium may also be a gas, in which case the quenching medium source 58 is a tank and a fan or compressor or other gas handling apparatus. The quenching medium, whether liquid or gas is flowed through the hollow interior of the tube assembly 10 until the local region 42 has been cooled. The quenching medium is then drained, the inlet and outlet seals removed, and the tube assembly 10 is unclamped from the locating fixture.

The foregoing description of the invention is merely exemplary in nature and, thus, variations thereof are intended to be within the scope of the invention. It will be understood that the heat treating can be performed at any selection region along the length of the tube assembly 10, wherever it is desired to affect the microstructure by heat treatment and quenching. The induction coil 36 can be repositioned along the length of the tube assembly 10, or a plurality of such induction coils can be employed to enable the heat treatment of several regions at the same time. Alternatively, the local regions of the tube can be heated by flame heating or laser heating or other know heating methods. Fixtures are provided in the number and at the locations that assure that the heating and cooling of the selected regions do not cause sagging or distortion of the precisely formed, shaped and sized tube assembly.

What is claimed is:

1. A method for manufacturing a heat treated tubular structure comprising:
providing a length of tube by the preassembly of tubular portions end to end;
forming the tube to a desired shape;
supporting the formed tube in a locating fixture having a plurality of supports spaced along the tube;
heating the tube in at least one local region to a temperature to heat treat the local region;
and quenching the heated local region of the tube by flushing a quenching medium through the tube.

2. The method of claim 1 comprising said quenching medium being a gas.

3. The method of claim 1 comprising said quenching medium being a liquid.

4. The method of claim 1 comprising said tube being preassembled by either the end-to-end welding of tube portions of differing material characteristic or the end to end welding of blanks of differing characteristic that are then rolled to tube shape and edge welded.

5. The method of claim 1 comprising said forming of the tube being a bending operation.

6. The method of claim 1 comprising said tube being hydroformed prior to being supported in the locating fixture.

7. The method of claim 1 comprising heating the local area of the tube after the tube is supported in the locating fixture.

8. The method of claim 1 comprising heating of the local area of the tube by placing an induction coil around the tube and conducting electric current through the induction coil.

9. The method of claim 8 comprising supporting the tube in the locating fixture and then thereafter conducting the electric current through the induction coil.

10. A method for manufacturing a tubular structure comprising:
welding together end to end a plurality of hollow tube portions to provide a length of assembled hollow tube;
forming the tube to a desired shape;
supporting the formed tube in a locating fixture having a plurality of tube supports spaced along the tube;
heating the tube at at least one local region along the length thereof;
installing an inlet seal at one end of the tube and an outlet seal at the other end of the tube;
and flowing a quenching medium through inlet seal, through the hollow tube, and out the outlet seal to rapidly cool and quench the heated local area of the tube by flushing the entire length of the tube with the quenching medium.

11. The method of claim 10 further comprising the quenching medium being either a liquid or a gas.

12. The method of claim 10 in which the forming of the tube is at least one of bending of the tube along its longitudinal length or hydroforming of the tube to form its cross-sectional shape.

13. The method of claim 10 in which the local region that is heated is a region that has been previously formed.

14. The method of claim 10 comprising the heating being performed by at least one of a laser, an induction coil or a flame.

15. A method for manufacturing a tubular structure comprising:
providing a plurality of lengths of tube portions differing from one another in at least one characteristic;
welding the tube portions together end to end to a make a single tube having a continuous open hollow interior;
forming the tube to a desired shape by lengthwise tube bending and cross-sectional hydroforming;
fixedly supporting the formed tube in a locating fixture having a plurality of supports spaced along the tube;
heating the tube in at least one local area to a temperature of 850 to 950 degrees;
clamping the tube in a plurality of tube supports spaced along the length of the tube prior to the heating so that the tube is supported against distortion by the heating;
and quenching the heated local area of the tube by flushing a quenching medium through the continuous open hollow interior of the tube.

16. The method of claim 15 further comprising the forming being a tube bending operation performed either before or after the welding together of the tube portions.

17. The method of claim 15 further comprising the forming being a hydroforming operation performed either before or after the welding together of the tube portions.

18. The method of claim 15 further comprising the forming being a tube bending operation and a hydroforming operation.
